(19) United States
(12) Patent Application Publication
(10) Pub. No.: US 2025/0322217 A1
(43) Pub. Date: Oct. 16, 2025

(54) SYSTEM, METHOD, AND COMPUTER PROGRAM FOR USING A GENERATIVE MODEL TO PROVIDE SEAMLESS ADAPTATION OF CONTENT TO THE REQUIREMENTS OF AN AREA OF JURISDICTION

(71) Applicant: Amdocs Development Limited, Limasol (CY)

(72) Inventors: Adi Lachman, Tel Mond (IL); Pavel Yefim May, Rishon leZion (IL)

(21) Appl. No.: 19/169,291

(22) Filed: Apr. 3, 2025

Related U.S. Application Data
(63) Continuation-in-part of application No. 18/632,156, filed on Apr. 10, 2024.

(51) Int. Cl. G06N 3/0475

(52) U.S. Cl. CPC G06N 3/0475

(57) ABSTRACT

As described herein, a system, method, and computer program are provided for using a generative model to adapt a content. The content and an indication of one or more content requirements are processed to determine one or more elements of the content that are not in compliance with the content requirements. A generative model is used to adapt the one or more elements of the content to the one or more content requirements. The content having the one or more adapted elements is output.

### RELATED APPLICATIONS

The present application is a continuation in part of U.S. application Ser. No. 18/632,156 (Attorney Ref: AMDCP871/81057569), filed Apr. 10, 2024 and entitled “SYSTEM, METHOD, AND COMPUTER PROGRAM FOR EXPLAINABILITY OF ENTITY DATA SEGMENTATION BASED ON BOOLEAN FRICTION POINTS,” the entire contents of which is incorporated herein by reference.

### FIELD OF THE INVENTION

The present invention relates to using artificial intelligence for content creation.

### BACKGROUND

Content is usually created in the context of and/or under the guidelines of the area of jurisdiction where it was created. The area of jurisdiction may refer to the geographical area controlled by a particular government, a company, an online platform, etc. For example, the content may be created to comply with local government laws, inside company rules, online platform restrictions or requirements, etc. However, when distributing the content to another area of jurisdiction, the content may be incompatible with the language, customs, norms and laws of that other area. In such cases, the content may not achieve optimal distribution, and can even be banned outright from a particular area unless it is adapted to meet compliance rules of that area.

To avoid this problem, content creators currently have three options available to them:

1. Create the content with the widest possible compliance—This is difficult to do, as there are wide ranges of rules and laws, as well as human preferences that vary across areas (what might attract people in one area might repel people in another).

2. Rate and label the content-content is usually given a rating (e.g. “PG-13”), and can have warning labels added to identify types of material in the content. However, in some areas certain elements may not be allowed regardless of rating. Also, some content ratings may put the content out of reach of its intended audience—for example, a kid-focused content with an adult rating will make it unavailable to the primary intended audience of the content.

3. Modify the content—the content can be modified to fit the needs of an area. Subtitles or dubbing can be added, and certain scenes can be cut out or masked. In video, masking can take the form of blurring, covering up with a color or image, and other methods of masking. In audio, a non-compliant audio can be beeped, muted, dubbed over, or otherwise masked. Either way, the modification is typically very noticeable to the content consumer and can degrade the experience of consuming it. The modification is also oftentimes done manually which is time consuming and costly.

There is thus a need for addressing these and/or other issues associated with the prior art. For example, there is a need to use a generative model to seamlessly adapt a content to the needs of an area of jurisdiction, such that the adaption may not be noticeable by the consumer and accordingly will not hurt the consumption experience.

### SUMMARY

As described herein, a system, method, and computer program are provided for using a generative model to adapt a content. The content and an indication of one or more content requirements are processed to determine one or more elements of the content that are not in compliance with the content requirements. A generative model is used to adapt the one or more elements of the content to the one or more content requirements. The content having the one or more adapted elements is output.

### BRIEF DESCRIPTION OF THE DRAWINGS

FIG. 1 illustrates a method for using a generative model to adapt a content, in accordance with one embodiment.

FIG. 2 illustrates a system for using a generative model to adapt a content, in accordance with one embodiment.

FIG. 3 illustrates a method for using a generative model to adapt a content to jurisdiction-specific content requirements, in accordance with one embodiment.

FIG. 4 illustrates a network architecture, in accordance with one possible embodiment.

FIG. 5 illustrates an exemplary system, in accordance with one embodiment.

### DETAILED DESCRIPTION

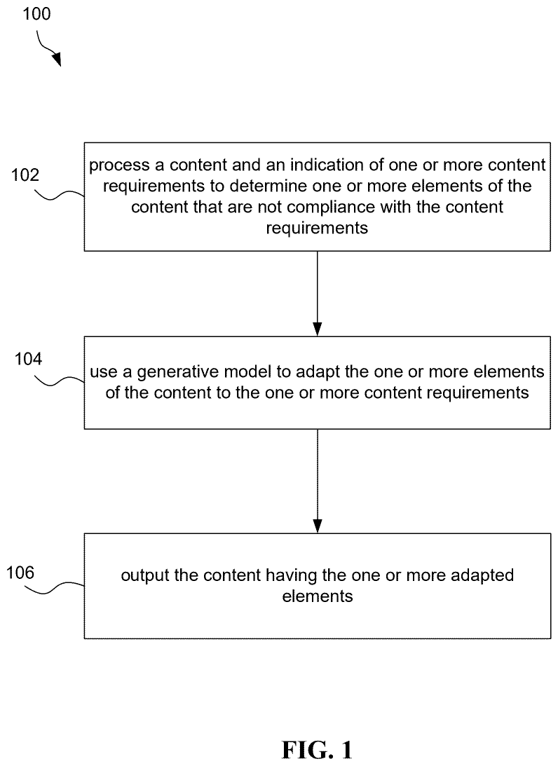

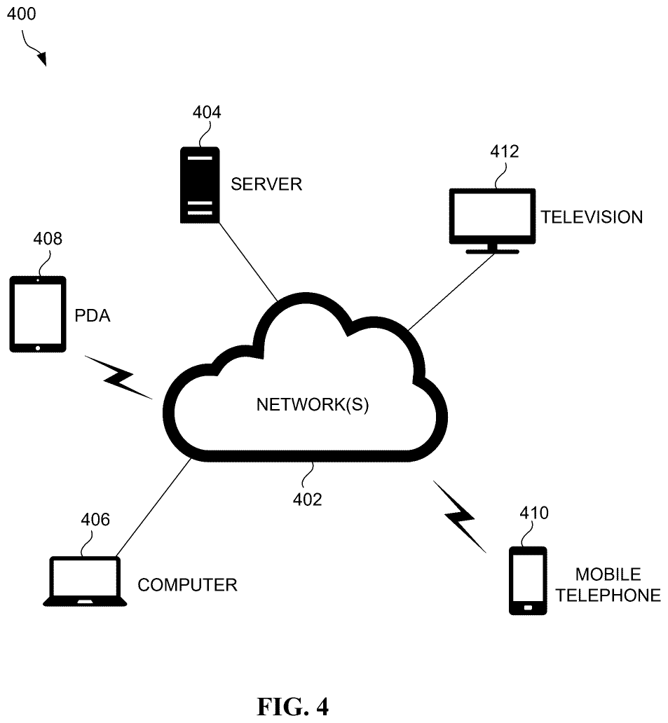

FIG. 1 illustrates a method 100 for using a generative model to adapt a content, in accordance with one embodiment. The method may be carried out by a computer system, such as that described below with respect to FIGS. 4 and/or 5.

In operation 102, a content and an indication of one or more content requirements are processed to determine one or more elements of the content that are not in compliance with the content requirements. With respect to the present description, the content refers to any media content intended for consumption by a user. For example, the content may be any data, text, video, sounds (audio), images, graphics, music, photographs, advertisements, and/or any combination of the same. The content may be generated by a human or an automated process (e.g. a generative model).

The content requirements refer to requirements for one or more elements capable of being included in a given content. The content requirements may be specified for types of elements capable of being included in a given content. These elements may include, for example, humans depicted in content, language included in content, specific words included in content, graphic scenes depicted in content, objects depicted in content, etc. Further, examples of the content requirements include a requirement to not depict nudity, a requirement to not depict gory scenes, a requirement to not depict certain objects, a requirement to not include certain (e.g. vulgar) words, a requirement to provide the audio in a certain language, etc.

In an embodiment, the content requirements may be defined for one or more areas of jurisdiction, which may be geographical regions or virtual regions. For example, the content requirements may be defined to reflect the laws, norms, preferences, etc. of different geographical regions controlled by different governments and/or of different virtual regions controlled by different companies, online platforms, etc. In an embodiment, the one or more content requirements may be selected based upon a given area of jurisdiction.

In an embodiment, the one or more content requirements may be selected from a library of content requirements. For example, the library may store a plurality of content requirements by area of jurisdiction. As briefly mentioned above, the plurality of content requirements may be at least in part configured based upon content-related laws or requirements of a plurality of different areas of jurisdiction. When an area of jurisdiction is given, the content requirements corresponding to that area may be selected from the library.

Of course, the one or more content requirements may be determined, or selected from the library, based upon any given criteria which may not necessarily include an area of jurisdiction. For example, the one or more content requirements may be determined based on a given content rating (e.g. “G,” “PG-13,” “R”, etc.).

As mentioned, the content and the indication of one or more content requirements are processed to determine one or more elements of the content that are not in compliance with the content requirements, hereinafter referred to as non-compliant elements. These non-compliant elements may be video elements, audio elements, etc. In an embodiment, the one or more non-compliant elements may be determined by a computer process configured to scan the content for certain elements specified by the content requirements and to identify when those elements do not comply with the content requirements. In an embodiment, the computer process may employ a machine learning model which determines the non-compliant elements.

In an embodiment, the content and the indication of the one or more content requirements may be further processed to determine one or more modification actions to use to adapt the one or more non-compliant elements to the content requirements. In an embodiment, the one or more modification actions may be determined using a machine learning model. In an embodiment, the one or more modification actions may be determined from a library, such as the library described above. For example, the one or more modification actions may be correlated with the content requirements with which the one or more elements of the content are not in compliance.

In an embodiment, the modification actions may be customized per content requirement or may be a default modification action to be used when no custom modification action is defined for a particular content requirement. In other words, at least one modification action of the one or more modification actions determined as to be used for adapting the non-compliant elements may be customized for at least one such non-compliant element. As another option, at least one modification action of the one or more modification actions determined as to be used for adapting the non-compliant content elements may be a default modification action that is used for at least one such non-compliant element when no customized modification action is configured for that element.

In operation 104, a generative model is used to adapt the one or more elements of the content (i.e. the non-compliant elements) to the one or more content requirements. With respect to the present description, the generative model refers to an artificial intelligence (AI) model that is trained to generate content for a given input. In the present embodiment, the non-compliant elements may be input to the generative model to cause the generative model to adapt those elements to the content requirements. It should be noted that the generative model may refer to a plurality of generative models, each configured to adapt a different type of content and/or to perform a different modification action.

In an embodiment, the generative model may also use the one or more modification actions described above to adapt the one or more elements of the content that are not in compliance with the content requirements. Adapting a content element to a content requirement refers to modifying the element or a portion of the content including the element such that the element or the portion of the content complies with the content requirement. In an embodiment, adapting the one or more elements may include replacing at least one element of the one or more elements with at least one newly generated element. In another embodiment, adapting the one or more elements may include masking at least one element of the one or more elements.

In an embodiment, the generative model may further adapt the non-compliant elements based on a given additional content and/or given additional instructions. For example, the given additional content and/or instructions may be separate from the content requirements. Just by way of example, the given additional content may be a dubbing audio track to which the content is to be adapted (e.g. by digitally modifying the lip movements of the actors in the video to match the dubbed audio).

In operation 106, the content having the one or more adapted elements, also referred to as the adapted content, is output. In an embodiment, the adapted content may be published (e.g. to a website, streaming television service, streaming music service, etc.). In an embodiment, the adapted content may be published for consumption by a user. In an embodiment, the adapted content may be published for access by users residing in the area of jurisdiction for which the content requirements were defined.

To this end, the method 100 may adapt the content to certain content requirements (e.g. which may be area-specific) in a streamlined manner by using the generative model. It should be noted that the method 100 may be employed to adapt the same content multiple different times to different sets of content requirements, including for example to adapt the content to multiple different areas of jurisdiction.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

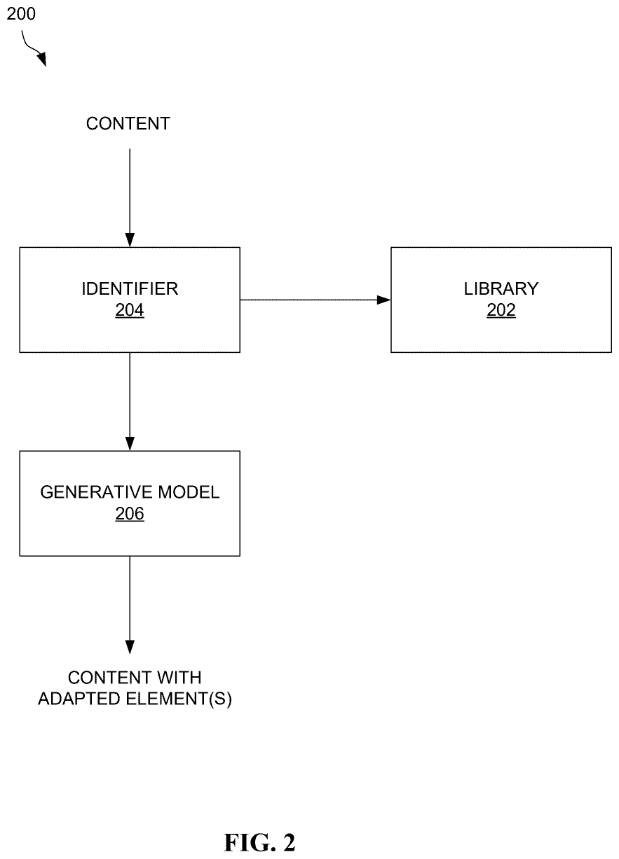

FIG. 2 illustrates a system 200 for using a generative model to adapt a content, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below. With respect to the present embodiment, it should be noted that the components 202-206 described herein may be implemented in computer hardware, software, or a combination thereof.

As shown, the system 200 includes an identifier 202 which is configured to process content and an indication of one or more content requirements to determine one or more elements of the content that are not in compliance with the content requirements. The identifier 202 interfaces a library 204 of the system which stores the content requirements, as well as optionally modification actions that can be used to adapt content elements to comply with the content requirements. The system 200 also includes a generative model 206 that processes output of the identifier 202 to adapt the content to the content requirements.

When a content is input to the identifier 202, the identifier 202 retrieves from the library 204 one or more content requirements for the content. The identifier 202 may retrieve content requirements defined for a specified area of jurisdiction and/or a specified content rating, for example. Of course, any criteria may be used by the identifier 202 to retrieve a subset of content requirements from the library 204.

The identifier 202 then uses the content requirements retrieved from the library 204 to determine one or more elements of the content that are not in compliance with the content requirements. The identifier 202 may identify the non-compliant elements via an automated computer process, which may involve scanning the content and/or processing the content using a machine learning model. In an embodiment, the identifier 202 may determine modification actions to be used to adapt the non-compliant elements to the content requirements. These modification actions may be retrieved from the library 204, in an embodiment.

The identifier 202 then inputs an indication of the non-compliant elements and optionally an indication of the content requirements to which the elements do not comply and/or the modification actions, to the generative model 206. The generative model 206 processes the input to adapt the non-compliant elements to the content requirements. The generative model 206 then outputs the content having the adapted elements. This output may be further processed by another component (not shown) to publish the content to a specified location.

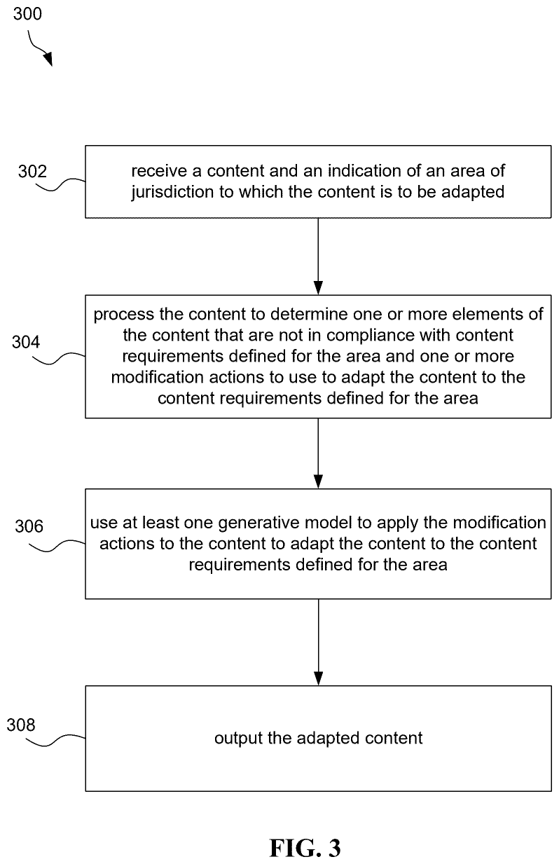

FIG. 3 illustrates a method 300 for using a generative model to adapt a content to jurisdiction-specific content requirements, in accordance with one embodiment. As an option, the flow diagram may be implemented in the context of the details of the previous figure and/or any subsequent figure(s). Of course, however, the flow diagram may be implemented in the context of any desired environment. Further, the aforementioned definitions may equally apply to the description below.

When content is created, it sometimes needs to be adapted to the requirements of an area of jurisdiction, including customs and regulations. There are various methods that are employed today to adapt the content to the needs of a given area of jurisdiction, but all of them leave a mark on the content that is apparent to the consumer and can hurt their experience in consuming it. The present method 300 provides a way in which generative AI can be employed to create a seamless adaptation to the needs of an area of jurisdiction, which is not noticeable by the consumer and does not hurt the consumption experience.

In operation 302, a content and an indication of an area of jurisdiction to which the content is to be adapted are received. The area of jurisdiction refers to a geographical area and/or a virtual area. In an embodiment, some rules may be defined for a virtual area, rather than being related to a physical geographic one controlled by a governing entity. For example, there can be an online community or online platform that publishes a set of rules for contents that will be displayed, or otherwise made accessible, through it. Also, it could be that a particular company, online or otherwise, may set its own rules as well.

Adapting the content to the area refers to adapting the content to content requirements defined for the area. The content and the indication of the area may be provided by a user (e.g. via a user interface of a program performing the method 300) or by an automated process (e.g. via an application programming interface to the program performing the method 300).

In operation 304, the content is processed to determine one or more elements of the content that are not in compliance with content requirements defined for the area and one or more modification actions to use to adapt the content to the content requirements defined for the area. In an embodiment, a library of content requirements for different areas of jurisdiction may be queried for the content requirements of the region indicated in operation 302. Table 1 illustrates various examples of area content requirements.

TABLE 1
1. Restriction of nudity - body parts that cannot be shown unclothed
2. Dress code - types of dress allowed and disallowed (e.g. no
bikinis or speedos)
3. Profanity or explicit language - blacklists of words or phrases
not allowed
4. Violence - level of violence allowed (none, no blood, mild blood,
etc.)

In an embodiment, the library may also store content requirements by content rating. In this case where the content is also to be adapted to a given content rating (e.g. “G,” “PG,” “PG-13,” “R,” etc.), the library may be queried for the content requirements of the region indicated in operation 302 as well as for the given content rating.

Processing the content to determine one or more elements of the content that are not in compliance with content requirements defined for the area may include a computer process scanning the content for the non-compliant elements or a machine learning model inferring the non-compliant elements.

As mentioned, one or more modification actions to be used to adapt the content to the content requirements defined for the area (and potentially the given rating) are also identified. In an embodiment, the library may store the modification actions in association with the content requirements, such that when a content requirement is not met then the modification action associated with it in the library may be used to adapt the content to that content requirement. Table 2 illustrates various examples of modification actions.

TABLE 2

1. Covering up nudity
2. Modifying dress to fit the code
3. Changing disallowed language to acceptable language
4. Reducing or eliminating visual impacts of violence

For any content requirement not having a modification action associated therewith, a default modification action may be used to adapt the content to that content requirement. For example, the default modification action for a scene in a video having a non-compliant element may be to cut out the scene from the video or mask the scene in the video.

In operation 306, at least one generative model is used to apply the modification actions to the content to adapt the content to the content requirements of the area (and potentially the given rating). In an embodiment, different generative models may be used to perform different types of modification actions. In an embodiment, the generative model may employ deep fake methodology. In an embodiment, at least one additional computer process (not necessarily a generative model) may be used to adapt the content as well. Table 3 illustrates various examples of the output of a generative model.

1. Digitally generated clothing over nude skin so it is no longer
visible (e.g., a topless woman can have a shirt drawn over her body)
2. Digitally generated a more covering set of clothing over a
revealing one (e.g. a man wearing a speedo can have trunks drawn
over the speedo)
3. Replaced profanity with non-profane utterances, and modified
the speaker's lip movement to match the changed word
4. Digitally removed blood from a fight scene, or digitally covered
up an open wound

The generative model (or additional computer process) can also receive specific modification instructions related to a specific content, beyond the provided modification actions (e.g. determined from the library). For example, a dubbing audio track can be provided to the generative model (or additional computer process) to cause a digital modification of the lip movements of the actors on the screen to match the dubbed audio.

In operation 308, the adapted content is output. For example, the adapted content may be published (e.g. to a website, streaming television service, streaming music service, etc.). In an embodiment, the adapted content may be published for consumption by a user. In an embodiment, the adapted content may be published for access by users within the area defined in operation 302.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

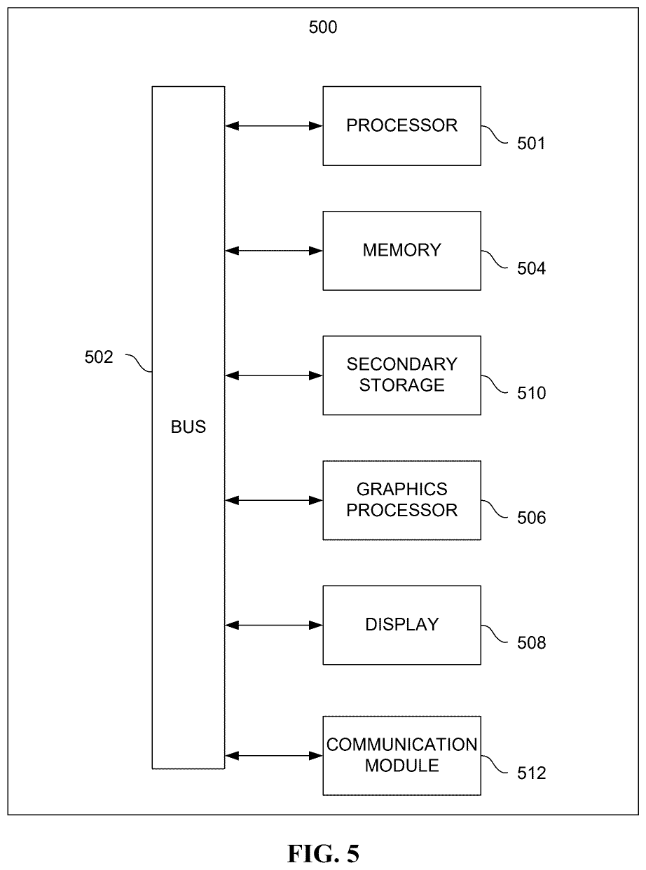

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
process a content and an indication of one or more content requirements to determine one or more elements of the content that are not in compliance with the content requirements;
use a generative model to adapt the one or more elements of the content to the one or more content requirements; and
output the content having the one or more adapted elements.

2. The non-transitory computer-readable media of claim 1, wherein the content is one of an image, a video, or an audio.

3. The non-transitory computer-readable media of claim 1, wherein the one or more content requirements are selected from a library of content requirements.

4. The non-transitory computer-readable media of claim 3, wherein the library stores a plurality of content requirements by geographical region.

5. The non-transitory computer-readable media of claim 4, wherein the plurality of content requirements are at least in part configured based upon content-related laws of a plurality of different geographical regions.

6. The non-transitory computer-readable media of claim 1, wherein the content and the indication of the one or more content requirements is further processed to determine one or more modification actions to use to adapt the one or more elements of the content that are not in compliance with the content requirements.

7. The non-transitory computer-readable media of claim 6, wherein the one or more modification actions are determined from a library.

8. The non-transitory computer-readable media of claim 7, wherein the one or more modification actions are correlated with the content requirements with which the one or more elements of the content are not in compliance.

9. The non-transitory computer-readable media of claim 6, wherein at least one modification action of the one or more modification actions is customized for at least one element of the one or more elements of the content that are not in compliance with the content requirements.

10. The non-transitory computer-readable media of claim 9, wherein at least one modification action of the one or more modification actions is a default modification action that is used for at least one element of the one or more elements when no customized modification action is configured for the at least one element.

11. The non-transitory computer-readable media of claim 6, wherein the one or more modification actions are determined using a machine learning model.

12. The non-transitory computer-readable media of claim 6, wherein the generative model further uses the one or more modification actions to adapt the one or more elements of the content that are not in compliance with the content requirements.

13. The non-transitory computer-readable media of claim 1, wherein adapting the one or more elements includes replacing at least one element of the one or more elements with at least one newly generated element.

14. The non-transitory computer-readable media of claim 1, wherein adapting the one or more elements includes masking at least one element of the one or more elements.

15. The non-transitory computer-readable media of claim 1, wherein the one or more elements include at least one video element.

16. The non-transitory computer-readable media of claim 1, wherein the one or more elements include at least one audio element.

17. The non-transitory computer-readable media of claim 1, wherein the generative model further adapts the one or more elements of the content based on a given additional content.

18. The non-transitory computer-readable media of claim 1, wherein outputting the content includes publishing the content for consumption by a user.

19. A method, comprising:
at a computer system:
processing a content and an indication of one or more content requirements to determine one or more elements of the content that are not in compliance with the content requirements;
using a generative model to adapt the one or more elements of the content to the one or more content requirements; and
outputting the content having the one or more adapted elements.

20. A system, comprising:
a non-transitory memory storing instructions; and
one or more processors in communication with the non-transitory memory that execute the instructions to:
process a content and an indication of one or more content requirements to determine one or more elements of the content that are not in compliance with the content requirements;
use a generative model to adapt the one or more elements of the content to the one or more content requirements; and
output the content having the one or more adapted elements.
